(19) United States
(12) Patent Application Publication
(10) Pub. No.: US 2006/0094428 A1
(43) Pub. Date: May 4, 2006

(54) Handset register system and method

(75) Inventor: Maw-Liang Jou, Taipei (TW)

Correspondence Address: BRUCE H. TROXELL;SUITE 1404, 5205 LEESBURG PIKE, FALLS CHURCH, VA, 22041, US

(73) Assignee: Inventec Appliances Corp.

(21) Appl. No.: 10/979,323

(22) Filed: Nov. 3, 2004

(51) Int. Cl. H04Q 7/20

(52) U.S. Cl. 455/435.1

(57) ABSTRACT

A handset register system allowing a user to enter register data through a register menu on a handset to perform register process in a customer service center includes a user database and a receiving device. The user database stores the register data of a plurality of users. The receiving device is located in the customer service center to receive the register data and store the register data in the user database.

### BACKGROUND OF THE INVENTION

(1) Field of the Invention

The present invention relates to a handset register system and particularly to a register (recording) process and method performed in a customer service center through a handset.

(2) Description of the Prior Art

The rapid technology developments and innovations in semiconductor industry and digital signal processing (DSP) in recent years also have brought a great progress in the communication industry. In the three new areas of the communication industry (mobile communication, satellite communication and optical fiber communication), mobile communication has greatest impact on people's life. Some statistics show that in Taiwan every person has more than one handset on average. The penetration rate is the highest in the world. The importance of mobile phone is obvious.

As the handset has almost become a necessary item to people, many vendors have plunged into fabrication of handset and its related products. To meet user's requirements in the versatile and volatile handset market, a wide variety of products have been developed and introduced. They generally can be divided into two types: one focuses on function, and another focuses on style. Each has its own appeal and market. From vendor's point of view, to meet user's requirements is the first priority. Hence one of the trends in the industry is to shift from “manufacturing industry” to “manufacture service industry”.

The first object of service is to understand customer and satisfy customer's needs, then the products that meet customer's satisfaction can be developed. Effective after sale services also can improve customer's satisfaction on the products. Refer to FIG. 1 for a conventional method for processing return warranty cards. Customers first fill out a product return warranty card 10 after having purchased a product. The return warranty card 10 is mailed to a designated location. The contents filled by the customers are important sources of customer data that can be utilized for various purposes.

However, such an approach has drawbacks, such as the vendor has to hire additional manpower to store customer's data for later on statistics and summary processing. Manpower cost increases. It also is less effective. Moreover, the data filled in the return warranty card 10 could be incomplete. As a result, data obtained from the return warranty card 10 is limited. Some customers do not care to fill and return the return warranty card 10 at all. Hence the return rate of the return warranty card 10 is difficult to control. When the customer mails the return warranty card 10 also is uncontrollable. This affects the data timeliness. With the product life cycle shortened constantly, data timeliness becomes very important. In view of these concerns, the invention aims to provide a handset register (recording) system and method that enable a handset to do register directly to a customer service center.

### SUMMARY OF THE INVENTION

Accordingly, it is one object of the present invention to provide a handset that requires a user to enter register (recording) data on a register menu at the first time of handset operation and send a short message to a customer service center to complete the register (recording) process.

It is another object of the present invention to provide a handset register (recording) system that requires a user to enter register data through a register menu at the first time of handset operation and send a short message to a customer service center to complete the register process.

It is one more object of the present invention to provide a handset register method that requires a user to enter register data on a register menu at the first time of using a handset and sends a short message to a customer service center to complete the register process.

In one aspect of the present invention, the handset register system enables a user to enter register data through a register menu on a handset at the first time of handset operation and send a short message to a customer service center to do registration. The handset register system includes a handset, a system vendor and a customer service center. The customer service center has a user database, a receiving device, a server and a transmission device. The user database stores the register data of a plurality of users, including name, sex, birthday, occupation, e-mail address, etc. The system vendor receives the register data sent from the handset of the user, and transfers the data to the receiving device of the customer service center. The receiving device is located in the customer service center to receive the register data and store the register data in the user database. The receiving device of the invention consists of a plurality of handsets. The transmission device sends a register succeeded short message to the user after user's register data have been stored in the user database and the server has retrieved user's phone number from the user database.

In another aspect of the present invention, the handset provided in the invention includes an input unit, a register menu and a transceiver. The register menu appears on the handset screen at the first time of handset operation to provide desired fields on the register menu for the user. User can enter the register data through an input interface such as a key pad, a writing pad, and the like. The transceiver transmits the register data to a selected receiving location and receives the register succeeded short message from the selected receiving location. The selected receiving location is the customer service center. In addition, the customer service center has a receiving device and a user database. The receiving device consists of a plurality of handsets to receive user's register data. The user database stores user's register data.

In a further aspect of the present invention, the handset register method according to the invention aims to allow a user to do register to the customer service center. It includes the following procedures: first, enter user's register data through a register menu at the first time of handset operation, the register menu includes fields such as name, sex, birthday, occupation, e-mail address, and the like; next, transmit the register data by a short message to a receiving device which consists of a plurality of handsets in this invention; then store the register data in a user database which is located in the customer service center with the receiving device; finally the server of the customer service center processes customer's data schedule and transfers to a transmission device which sends a register succeeded short message to the user to complete the register process.

The foregoing, as well as additional objects, features and advantages of the invention will be more readily apparent from the following detailed description, which proceeds with reference to the accompanying drawings.

### BRIEF DESCRIPTION OF THE DRAWINGS

The present invention will now be specified with reference to its preferred embodiment illustrated in the drawings, in which

FIG. 1 is a schematic view of a handset return warranty card;

FIG. 2 is a schematic view of the system architecture of an embodiment of the handset register system of the invention;

FIG. 3 is a schematic view of an embodiment of the handset register system of the invention in an operating condition; and

FIG. 4 is a process flow of an embodiment of the handset register method of the invention.

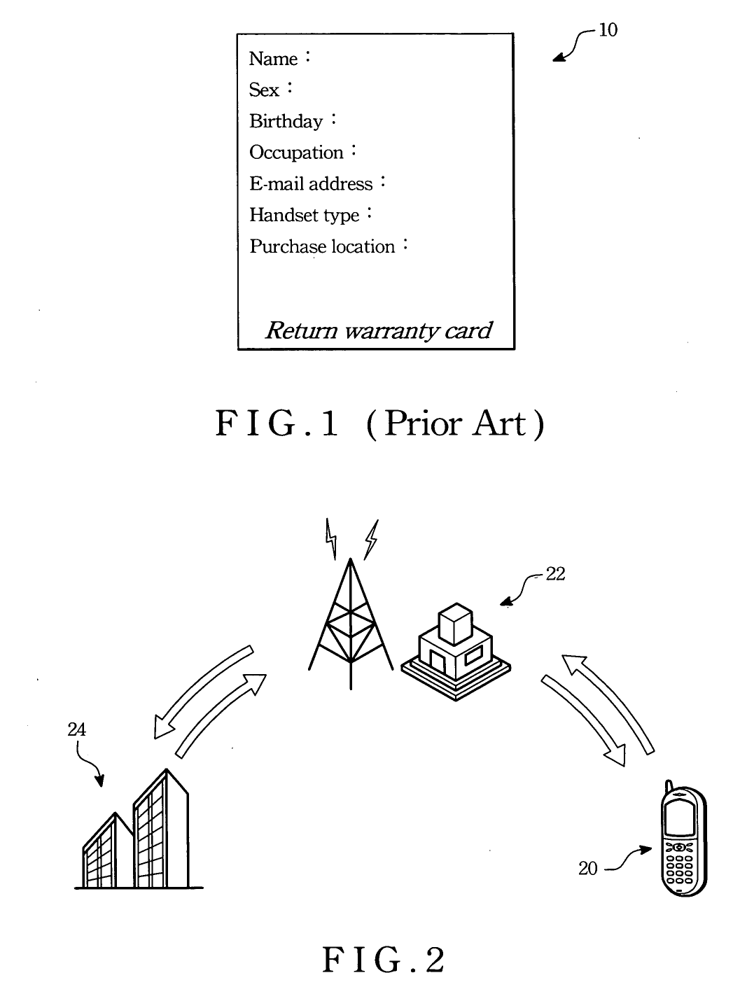

### DESCRIPTION OF THE PREFERRED EMBODIMENT

The invention provides a handset register system that enables a handset to do register (recording) directly to a customer service center. According to the invention, a user enters register data through a register menu on the handset (at the first time of handset operation), and sends a short message to the customer service center to complete the register (recording) process so that the handset manufacturer can obtain customer's data instantly to provide more comprehensive after sale services. Details are elaborated as follow through an embodiment. The embodiment is merely for illustrative purpose and is not the limitation of the invention.

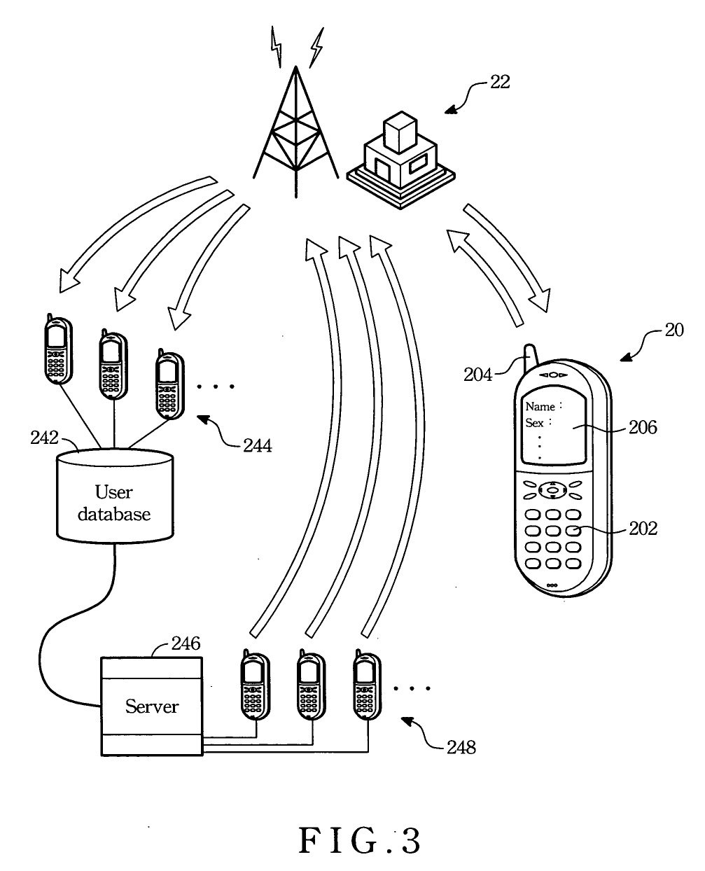

Refer to FIG. 2 for the system architecture of an embodiment of the handset register system according to the invention. The system can include a handset 20, a system vendor 22 and a customer service center 24. Also referring to FIG. 3, the customer service center 24 has a user database 242, a receiving device 244, a server 246 and a transmission device 248. When a user starts handset operation for the first time, he/she enters register data through a register menu 206 showing on the handset 20, and does registration by sending a short message to the customer service center 24 through the system vendor 22. The system vendor 22 may serve as an intermediate medium to receive the register data sent by the user of the handset 20, and transfer to the receiving device 244 in the customer service center 24.

Referring to FIG. 3, in an embodiment of the invention, the handset 20 may include an input device 202, a transceiver 204 and a register menu 206. The register menu 206 appears on the screen of the handset 20 at the first time of handset operation to provide desired fields of the register menu 206 to allow the user to enter register data through an input interface such as a key pad, a writing pad, or the like. The transceiver 204 can transmit the register data (includes IMEI code of the handset 20) to a selected receiving location (a preset phone number) by a short message, and receive a register succeeded short message from the selected receiving location. The selected receiving location can be the customer service center 24.

Also referring to FIG. 3, according to the embodiment of the invention, the customer service center usually has a user database 242, a receiving device 244, a server 246 and a transmission device 248. The user database 242 is to store the register data of a plurality of users received by the receiving devices 244 from the system vendors 22 (such as TCC-AT&T-Chunghwa Telecom-KG Telecom, etc.) that are captured and transferred from the register menu 206 of user's handset 20. The register data may include name, sex, birthday, occupation, e-mail address, handset type, purchase location, etc. The receiving device 244 may be located in the customer service center 24 to receive the register data transferred from the system vendors 22 and store the register data in the user database 242. The receiving device 244 of the invention consists of a plurality of handsets.

After user's register data have been stored in the user database 242, user's phone number is retrieved from the user database 242 by the server 246 which sends a data schedule at a desired time to the transmission device 248 to transmit a register succeeded short message to the user through the system vendor 22. The transmission device 248 in this invention consists of a plurality of handsets.

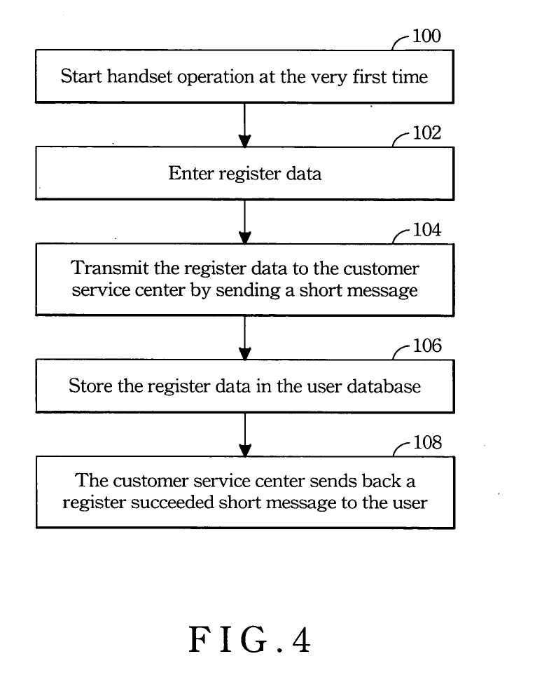

Refer to FIG. 4 for the process flow of an embodiment of the handset register method according to the invention that is adopted for a user to do register to the customer service center 24. The method includes the following procedures. Firstly is to start handset operation at first time (step 100). Next is to enter user's register data through the register menu 206 of the handset 20 (step 102). Subsequently is to transmit the register data by a short message from the handset 20 to the customer service center 24 (step 104). In this step, the register data can be transmitted first to the system vendor 22, than transferred to the handset of the receiving device 244 in the customer service center 24. Next, after the receiving device 244 in the customer service center 24 has received the register short message, the register data contained in the short message are stored in the user database 242 (step 106). Finally, the server 246 in the customer service center 24 may process schedules of customer data, and transmit a register succeeded short message through the transmission device 248 in the customer service center 24 to the user (step 108) so as to complete the register process.

The handset register system according to the invention provides the following advantages:

(1) Save manpower and labor cost that might otherwise require entering customer's return cards, and facilitate customer database setup, and benefit after sale services and implementation of marketing strategies.

(2) The handset register system proceeds the register process at the first time of handset operation after the handset is purchased, hence customer's data are transmitted and returned instantly after purchase, and can achieve 100% of successful register.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A handset register system allowing a user to enter register data through a register menu on a handset for performing register process to a customer service center, comprising:
a user database for storing the register data of a plurality of users; and
a receiving device located in the customer service center to receive the register data and store the register data in the user database.

2. The handset register system of claim 1, wherein the user enters the register data when the handset starts operation at the first time.

3. The handset register system of claim 1, wherein the register data are transmitted by a short message.

4. The handset register system of claim 1, wherein said receiving device includes a plurality of handsets.

5. The handset register system of claim 1 further including a system vendor to receive the register data sent by the user and transfer the register data to said receiving device.

6. The handset register system of claim 1 further including a transmission device and a server which retrieves a phone number of the user from said user database after the register data of the user have been stored in said user database, said transmission device including a plurality of handsets sending a register succeeded short message to the user.

7. The handset register system of claim 1, wherein the register data include the fields of name, sex, birthday, occupation and electronic mail address.

8. A handset comprising:
an input unit;
a register menu displaying on a screen of the handset when the handset starts operation at the first time to allow a user to enter register data on fields of the register menu; and
a transceiver to transmit the register data to a selected receiving location and receive a register succeeded short message from the selected receiving location.

9. The handset of claim 8, wherein the selected receiving location is a customer service center which has a user database to store the register data.

10. The handset of claim 9, wherein the customer service center has a receiving device including a plurality of handsets to receive the register data.

11. The handset of claim 9, wherein the customer service center has a transmission device including a plurality of handsets to send back the register succeeded short message to the user.

12. The handset of claim 8, wherein the input unit is selectively a key pad or a writing pad.

13. The handset of claim 8, wherein the register data include the fields of name, sex, birthday, occupation and electronic mail address.

14. A handset register method for a user to do register to a customer service center, comprising the steps of:
entering user's register data through a register menu when the handset starts operation at the first time;
sending the register data to a receiving device by a short message;
storing the register data in a user database; and
sending back a register succeeded short message to the user.

15. The handset register method of claim 14, wherein both said receiving device and said user database are located in said customer service center.

16. The handset register method of claim 14, wherein said receiving device includes a plurality of handsets.

17. The handset register method of claim 14, wherein the sending back a register succeeded short message to the user is accomplished through a transmission device.

18. The handset register method of claim 17, wherein said transmission device includes a plurality of handsets.

19. The handset register method of claim 14, wherein the register data include the fields of name, sex, birthday, occupation and electronic mail address.
